(19) United States
(12) Patent Application Publication
(10) Pub. No.: US 2023/0391659 A1
(43) Pub. Date: Dec. 7, 2023

(54) GLASS MATERIAL

(71) Applicant: NIPPON ELECTRIC GLASS CO., LTD., Otsu-shi, Shiga (JP)

(72) Inventor: Futoshi SUZUKI, Otsu-shi (JP)

(21) Appl. No.: 18/035,800

(22) PCT Filed: Dec. 14, 2021
(86) PCT No.: PCT/JP2021/046036

§ 371 Date: May 8, 2023

(30) Foreign Application Priority Data
Dec. 16, 2020 (JP) 2020-208342
Mar. 30, 2021 (JP) 2021-057981

(51) Int. Cl. C03C 3/068; C03C 4/00

(52) U.S. Cl. CPC C03C 3/068; C03C 4/0092

(57) ABSTRACT

The present invention provides a glass material exhibiting a high light transmittance at a working wavelength. The glass material includes, in terms of % by mole, from 26% to 40% of Tb₂O₃, greater than 12% and 40% or less of B₂O₃, from 1% to 20% of Al₂O₃, from 1% to 40% of SiO₂, from 0% to 5% of P₂O₅, and greater than 14% and 74% or less of B₂O₃+Al₂O₃+SiO₂+P₂O₅.

### TECHNICAL FIELD

The present invention relates to a glass material.

### BACKGROUND ART

It is known that a glass material containing Tb₂O₃ exhibits a Faraday effect as one of a magneto-optical effect. The Faraday effect causes rotation of linearly polarized light that is propagating through a material placed in a magnetic field. A magneto-optical element utilizing this effect (for example, a Faraday rotator) is used in a magneto-optical device such as an optical isolator.

The optical rotation (rotation angle of the plane of polarization) θ caused by the Faraday effect is expressed by the following equation. In the equation, H is the strength of the magnetic field, L is the length of the material through which the polarized light propagates, and V is a constant (Verdet constant) dependent on the type of material. The Verdet constant takes a positive value in the case of a diamagnetic material and a negative value in the case of a paramagnetic material. In addition, the larger the absolute value of the Verdet constant, the larger the absolute value of the optical rotation, which result in a large Faraday effect.
θ=VHL

Known glass materials exhibiting the Faraday effect include, for example, a SiO₂-B₂O₃-Al₂O₃Tb₂O₃-based glass material (Patent Document 1) and a P₂O₅-B₂O₃-Tb₂O₃-based glass material (Patent Document 2).

### CITATION LIST

### Patent Literature

Patent Document 1: JP 51-46524 B

Patent Document 2: JP 52-32881 B

### SUMMARY OF INVENTION

### Technical Problem

In recent years, laser light used to irradiate magneto-optical devices has increased in its output, and there has been a demand for improvement in the light transmittance of magneto-optical elements at a working wavelength (for example, from 300 to 1100 nm).

In view of the above, an object of the present invention is to provide a glass material that exhibits a high light transmittance at a working wavelength.

### Solution to Problem

A glass material according to the present invention includes, in terms of % by mole, from 26% to 40% of Tb₂O₃, greater than 12% and 40% or less of B₂O₃, from 1% to 20% of Al₂O₃, from 1% to 40% of SiO₂, from 0% to 5% of P₂O₅, and greater than 14% and 74% or less of B₂O₃+Al₂O₃+SiO₂+P₂O₅.

In the glass material according to the present invention, a content of FeO+Fe₂O₃ is preferably 10 ppm or less.

The glass material according to the present invention is preferably substantially free of Sb₂O₃ and As₂O₃.

In the glass material according to the present invention, a ratio of Tb³⁺ to the total Tb is, in terms of % by mole, preferably 55% or greater.

In the glass material according to the present invention, a light transmittance at a wavelength of 1064 nm is preferably 70% or greater.

The glass material according to the present invention is preferably for use as a magneto-optical element.

The glass material according to the present invention is preferably for use as a Faraday rotator.

### ADVANTAGEOUS EFFECTS OF INVENTION

The present invention can provide a glass material exhibiting a high light transmittance at a working wavelength.

### BRIEF DESCRIPTION OF DRAWINGS

FIG. 1 is a schematic cross-sectional view illustrating an embodiment of a device for manufacturing a glass material of the present invention.

### DESCRIPTION OF EMBODIMENTS

A glass material according to the present invention includes from 26% to 40% of Tb₂O₃, greater than 12% and 40% or less of B₂O₃, from 1% to 20% of Al₂O₃, from 1% to 40% of SiO₂, from 0% to 5% of P₂O₅, and greater than 14% and 74% or less of B₂O₃+Al₂O₃+SiO₂+P₂O₅. Reasons for defining the glass composition in this manner and the content of each component will be described below. In the description below, “%” means “mol %” unless otherwise indicated.

Tb₂O₃ is a component that increases the absolute value of the Verdet constant and increases the Faraday effect. The content of Tb₂O₃ is preferably from 26% to 40%, from 26% to 39%, from 26% to 36%, from 26% to 35%, from 28% to 35%, from 29% to 35%, or from 30% to 34%, and particularly preferably from 31% to 34%. When the content of Tb2O3 is too small, the effects described above are difficult to achieve. When the content of Tb₂O₃ is too large, vitrification is difficult. Note that Tb in the glass is present in the trivalent state or the quadrivalent state, but all of these states of Tb are expressed as Tb₂O₃ in the present invention.

A ratio of Tb³⁺ to the total Tb is, in terms of % by mole, preferably 55 mol % or greater, mol % or greater, 70 mol % or greater, or 80 mol % or greater, and particularly preferably 90 mol % or greater. Such a ratio reduces the proportion of Tb⁴⁺, which causes coloration of the glass material, and easily suppresses a decrease in the light transmittance of the glass material. Note that, Tb⁴⁺ has absorption at a wavelength from 300 to 1100 nm. When the ratio of Tb³⁺ to the total Tb is too small, the glass material is colored, the light transmittance in the above wavelength range decreases, and the glass material is likely to generate heat. The heat generated causes the thermal lens effect. Thus, when the glass material is irradiated with laser light, the beam profile of the laser light tends to deform.

B₂O₃ is a component that widens the vitrification range and that stabilizes vitrification. The content of B₂O₃ is preferably greater than 12% and 40% or less, from 13% to 40%, from 15% to 38%, from 16% to 36%, from 20% to 35%, from 21% to 35%, from 21% to 32%, or greater than 25% and 32% or less, and particularly preferably from 26% to 32%. When the content of B₂O₃ is too small, vitrification is difficult. When the content of B₂O₃ is too large, a sufficient Faraday effect is difficult to achieve. Thermal stability and hardness also tend to decrease.

Al₂O₃ is a component that forms a glass network, widens the vitrification range, and stabilizes vitrification. The content of Al₂O₃ is preferably from 1% to 20%, from 2% to 20%, from 3% to 20%, from 5% to 20%, from 7% to 20%, or from 10% to 20%, and particularly preferably from 11% to 19%. When the content of Al₂O₃ is too small, the effects described above are difficult to achieve. When the content of Al₂O₃ is too large, a sufficient Faraday effect is difficult to achieve.

SiO₂ is a component that forms a glass network, widens the vitrification range, and stabilizes vitrification. The content of SiO₂ is preferably from 1% to 40%, from 2% to 40%, from 2% to 39%, from 5% to 40%, from 10% to 38%, from 15% to 35%, from 18% to 32%, or from 20% to 32%. When the content of SiO₂ is too small, the effects described above are difficult to achieve. When the content of SiO₂ is too large, a sufficient Faraday effect is difficult to achieve.

P₂O₅ is a component that forms a glass network, widens the vitrification range, and stabilizes vitrification. The content of P₂O₅ is preferably from 0% to 5%, 0% or greater and less than 5%, from 0% to 4%, or from 0.1% to 4%, and particularly preferably from 1% to 4%. When the content of P₂O₅ is too large, a sufficient Faraday effect is difficult to achieve. Thermal stability and hardness also tend to decrease.

The content of B₂O₃+Al₂O₃+SiO₂+P₂O₅ (the total amount of B₂O₃, Al₂O₃, SiO₂, and P₂O₅) is preferably greater than 14% and 74% or less, from 20% to 74%, from 30% to 74%, from 40% to 74%, from 50% to 72%, from 55% to 71%, or from 60% to 70%, and particularly preferably from 60% to 69%. When the content of B₂O₃+Al₂O₃+SiO₂+P₂O₅ is too small, vitrification is difficult. When the content of B₂O₃+Al₂O₃+SiO₂+P₂O₅ is too large, a sufficient Faraday effect is difficult to achieve.

In addition to the components described above, the glass material according to the present invention may contain the following components.

La₂O₃, Gd₂O₃, Y₂O₃, and Yb₂O₃ are components that stabilize vitrification. The individual content of La₂O₃, Gd₂O₃, Y₂O₃, and Yb₂O₃ is preferably 10% or less, 7% or less, 5% or less, 4% or less, or 2% or less, and particularly preferably 1% or less. When the contents of these components are too large, vitrification is difficult.

Dy₂O₃, Eu₂O₃, and Ce₂O₃ are components contributing to the increase of the Verdet constant. The individual content of Dy₂O₃, Eu₂O₃, and Ce₂O₃ is preferably 1% or less, 0.5% or less, or 0.1% or less, and particularly preferably 0.01% or less. When the contents of these components are too large, light transmittance at a wavelength from 300 to 1100 nm decreases, and the glass material is likely to generate heat. The heat generated can lead to the thermal lens effect and cause deformation of the beam profile of laser light. Note that Dy, Eu, and Ce in the glass are present in the trivalent state or the quadrivalent state, but all of these states of Dy, Eu, and Ce are expressed as Dy₂O₃, Eu₂O₃, and Ce₂O₃, respectively, in the present invention.

Pr₂O₃ is a component contributing to the increase of the Verdet constant. The content of Pr₂O₃ is preferably 5% or less, 3% or less, or less than 1%, and particularly preferably 0.5% or less. When the content of Pr₂O₃ is too large, vitrification is difficult.

MgO, CaO, SrO, and BaO are components that stabilize vitrification and improve chemical durability. The individual content of MgO, CaO, SrO, and BaO is preferably from 0% to 10%, and particularly preferably from 0% to 5%. When the contents of these components are too large, a sufficient Faraday effect is difficult to achieve.

GeO₂ is a component that improves glass-forming ability. The content of GeO₂ is preferably 0% or greater and less than 60%, from 0% to 55%, from 0% to 50%, from 0% to 45%, from 0% to 40%, from 0% to 35%, from 0% to 30%, from 0% to 20%, from 0% to 15%, from 0% to 10%, from 0% to 9%, from 0% to 7%, or from 0% to 5%, and particularly preferably from 0% to 4%. When the content of GeO₂ is too large, a sufficient Faraday effect is difficult to achieve.

ZnO is a component that stabilizes vitrification. The content of ZnO is preferably from 0% to 20%, from 0% to 15%, from 0% to 13%, from 0% to 10%, from 0% to 8%, or from 0% to 5%, and particularly preferably from 0% to 4%. When the content of ZnO is too large, devitrification tends to occur. In addition, a sufficient Faraday effect is difficult to achieve.

Ga₂O₃ is a component that stabilizes vitrification and widens the vitrification range. The content of Ga₂O₃ is preferably from 0% to 6%, from 0% to 5%, or from 0% to 4%, and particularly preferably from 0% to 2%. When the content of Ga₂O₃ is too large, devitrification tends to occur. In addition, a sufficient Faraday effect is difficult to achieve.

Fluorine has the effect of increasing the glass-forming ability and widening the vitrification range. The content of fluorine (converted to F₂) is preferably from 0% to 10%, from 0% to 7%, from 0% to 5%, from 0% to 3%, or from 0% to 2%, and particularly preferably from 0% to 1%. . When the content of fluorine is too large, the component may volatilize during melting and adversely affect vitrification. In addition, striae are likely to occur.

In the glass material according to the present invention, the content of FeO+Fe₂O₃ (the total amount of FeO and Fe₂O₃) is preferably 10 ppm or less, 7 ppm or less, 5 ppm or less, 4 ppm or less, 2 ppm or less, or 1 ppm or less, and particularly preferably 0.8 ppm or less. Since FeO exhibits a broad absorption attributable to Fe²⁺ that peaks near the wavelength of 1200 nm, the light transmittance at a wavelength from 800 to 1200 nm decreases, and the glass material is likely to generate heat. In addition, Fe₂O₃ is reduced to FeO in the melting process, and may, similar to the case above, exhibit a broad absorption attributable to Fe²⁺. As such, when the content of FeO+Fe₂O₃ is too large, the thermal lens effect occurs, and the beam profile of laser light deforms easily. The lower limit of the content of FeO+Fe₂O₃ is, for example, preferably ppm or greater, 0.005 ppm or greater, 0.01 ppm or greater, or 0.05 ppm or greater, and particularly preferably 0.1 ppm or greater. When the content of FeO+Fe₂O₃ is too small, manufacturing costs tend to increase. Note that, the individual content of FeO and Fe₂O₃ is preferably 10 ppm or less, 7 ppm or less, 5 ppm or less, 4 ppm or less, 2 ppm or less, or 1 ppm or less, and particularly preferably 0.8 ppm or less. The lower limit of the individual content of FeO and Fe₂O₃ is, for example, preferably 0.001 ppm or greater, 0.005 ppm or greater, 0.01 ppm or greater, or 0.05 ppm or greater, and particularly preferably 0.1 ppm or greater.

The glass material according to the present invention is preferably substantially free of Sb₂O₃ and As₂O₃. When these components are contained, bubbles are likely to generate in the glass, and the light transmittance of the glass is likely to decrease. Note that, the phase “substantially free of” mentioned above means that no amount of these components are deliberately contained in the raw materials, and is not intended to exclude even the incorporation thereof in impurity level. Objectively, this means that the content of each component is less than 1000 ppm.

The glass material according to the present invention exhibits a good light transmittance in a range of wavelengths from 300 to 1100 nm. Specifically, the light transmittance at a wavelength of 1064 nm is preferably 70% or greater, or 75% or greater, and particularly preferably 80% or greater. The light transmittance at a wavelength of 633 nm is preferably 60% or greater, 65% or greater, 70% or greater, or 75% or greater, and particularly preferably 80% or greater. The light transmittance at a wavelength of 532 nm is preferably 30% or greater, 50% or greater, 60% or greater, or 70% or greater, and particularly preferably 80% or greater. Note that, the values of light transmittance mentioned above are values in a case in which the glass material has a thickness of 1 mm.

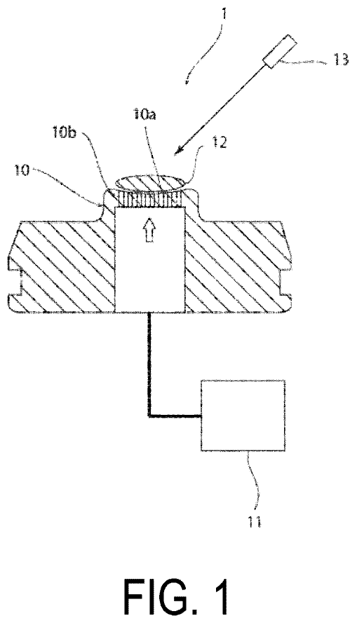

The glass material according to the present invention can be produced by, for example, the containerless levitation technique. FIG. 1 is a schematic cross-sectional view illustrating an embodiment of a device for manufacturing a glass material of the present invention. A method for manufacturing the glass material according to the present invention will be described with reference to FIG. 1.

A manufacturing device 1 for manufacturing glass material has a forming die 10. The forming die 10 also serves as a melting container. The forming die 10 has a forming surface 10a and a plurality of gas jet holes 10b opened at the forming surface 10a. The gas jet holes 10b are connected to a gas supply mechanism 11 such as a gas cylinder. Gas is supplied from the gas supply mechanism 11 via the gas jet holes 10b to the forming surface 10a. The type of gas is not limited. The gas may be, for example, air or oxygen, or may be nitrogen gas, argon gas, helium gas, carbon monoxide gas, carbon dioxide gas, or a reducing gas containing hydrogen. Among them, an inert gas is preferable for the purpose of increasing the ratio of Tb³⁺ in the total Tb and from the viewpoint of safety.

When using the manufacturing device 1 to manufacture a glass material, first, a glass raw material block 12 is placed on the forming surface 10a. Examples of the glass raw material block 12 include a single piece obtained by subjecting a raw material powder to press molding or the like, a sintered compact obtained by subjecting a raw material powder to press molding to form a single piece and then subjecting the single piece to sintering, and an aggregate of crystals having a composition equivalent to a target glass composition.

Next, gas is jetted out through the gas jet holes 10b, thus levitating the glass raw material block 12 above the forming surface 10a. That is, the glass raw material block 12 is kept in a state of not being in contact with the forming surface 10a. In this state, the glass raw material block 12 is irradiated with laser light from a laser light irradiation device 13. Thus, the glass raw material block 12 is heated and melted and goes through vitrification, resulting in a molten glass. Next, the molten glass is cooled, resulting in a glass material. At this time, the molten glass and the glass material are cooled until the temperature is at least equal to or lower than the softening point. In the step of heating and melting the glass raw material block 12 and the step of cooling the molten glass and the glass material to a temperature of at least equal to or lower than the softening point, it is preferred that at least the jetting of gas is continued to reduce the contact of the glass raw material block 12, the molten glass, and the resulting glass material with the forming surface 10a. The glass raw material block 12 may be levitated above the forming surface 10a by utilizing a magnetic force generated by the application of a magnetic field. In addition to the method of irradiation using laser light, radiation heating may be used as a method of heating and melting.

In the method for manufacturing a glass material according to the present invention, the raw material powder may contain a reducing agent. The reducing agent is preferably, for example, carbon, wood meal, aluminum metal, silicon metal, aluminum fluoride, or an ammonium salt.

The raw material powder preferably contains the reducing agent in an amount from 0 wt. % to 1 wt. %, from 0.01 wt. % to 0.9 wt. %, or from 0.1 wt. % to 0.8 wt. %, and particularly preferably from 0.1 wt. % to 0.7 wt. %. When the amount of the reducing agent is too small, the desired reduction effect is difficult to achieve, and the ratio of Tb³⁺, which will be described later, tends to decrease. When the amount of the reducing agent is too large, Fe₂O₃ in the raw material powder tends to be reduced to FeO. As a result, light transmittance at a wavelength from 800 to 1200 nm decreases, and the glass material is likely to generate heat.

The method for manufacturing a glass material according to the present invention is not limited to the containerless levitation technique described above. For example, the glass material according to the present invention may be produced by crucible melting. The glass material according to the present invention has the above-mentioned glass composition and thus can go through vitrification stably; even in the case of using crucible melting as the manufacturing method, the glass material can be obtained in a stable manner In addition, in the case of using crucible melting as the manufacturing method, a large amount of raw material powder can be melted at a time, and thus a large-sized glass material is easily achieved. The large-sized glass material can be suitably used in, for example, high power laser applications.

### EXAMPLES

Hereinafter, the present invention will be described based on Examples, but the present invention is not limited to Examples below.

Tables 1 to 3 illustrates Examples 1 to 10, Examples 12 to 16, and Comparative Example 11 of the present invention.

TABLE 1

| | | Examples | | | | | |
|---|---|---|---|---|---|---|---|
| | | 1 | 2 | 3 | 4 | 5 | 6 |
| Glass Composition | Tb₂O₃ | 26 | 34 | 33 | 29 | 30 | 31 |
| (mol %) | B₂O₃ | 25 | 24 | 25 | 32 | 28 | 22 |
| | Al₂O₃ | 17 | 12 | 14 | 15 | 18 | 20 |
| | SiO₂ | 30 | 28 | 28 | 20 | 24 | 26 |
| | P₂O₅ | 2 | 2 | 0 | 4 | 0 | 1 |

| | | | | | | |
|---|---|---|---|---|---|---|
| FeO + Fe₂O₃ (ppm) | 0.8 | 2 | 1 | 4 | 3 | 6 |
| B₂O₃ + Al₂O₃ + SiO₂ + P₂O₅ | 74 | 66 | 67 | 71 | 70 | 69 |
| Verdet constant @ 1064 nm (min/Oe · cm) | −0.083 | −0.134 | −0.131 | −0.099 | −0.110 | −0.113 |
| Transmittance @ 1064 nm (%) | 87.6 | 86.1 | 86.3 | 87.2 | 87.1 | 86.8 |

TABLE 2

| | | | | | | Comparative |
|---|---|---|---|---|---|---|
| | | Examples | | | | Example |
| | | 7 | 8 | 9 | 10 | 11 |
| Glass Composition | Tb₂O₃ | 32 | 36 | 38 | 40 | 26 |
| (mol %) | B₂O₃ | 20 | 26 | 27 | 30 | 25 |
| | Al₂O₃ | 13 | 12 | 7 | 8 | 30 |
| | SiO₂ | 32 | 22 | 25 | 20 | 2 |
| | P₂O₅ | 3 | 4 | 3 | 2 | 17 |

| | | | | | |
|---|---|---|---|---|---|
| FeO + Fe₂O₃ (ppm) | 8 | 4 | 1 | 5 | 40 |
| B₂O₃ + Al₂O₃ + SiO₂ + P₂O₅ | 68 | 64 | 62 | 60 | 74 |
| Verdet constant @ 1064 nm (min/Oe · cm) | −0.122 | −0.139 | −0.155 | −0.163 | −0.083 |
| Transmittance @ 1064 nm (%) | 86.6 | 86.4 | 85.7 | 85.3 | 69.2 |

TABLE 3

| | | Examples | | | | |
|---|---|---|---|---|---|---|
| | | 12 | 13 | 14 | 15 | 16 |
| Glass Composition | Tb₂O₃ | 32 | 30 | 31 | 29 | 40 |
| (mol %) | B₂O₃ | 13 | 40 | 16 | 34 | 39 |
| | Al₂O₃ | 13 | 15 | 19 | 20 | 14 |
| | SiO₂ | 39 | 15 | 29 | 13 | 2 |
| | P₂O₅ | 3 | 0 | 5 | 4 | 5 |

| | | | | | |
|---|---|---|---|---|---|
| FeO + Fe₂O₃ (ppm) | 4 | 1 | 2 | 3 | 5 |
| B₂O₃ + Al₂O₃ + SiO₂ + P₂O₅ | 68 | 70 | 69 | 71 | 60 |
| Verdet constant @ 1064 nm (min/Oe · cm) | −0.125 | −0.108 | −0.112 | −0.096 | −0.159 |
| Transmittance @ 1064 nm (%) | 85.8 | 86.2 | 85.8 | 85.6 | 84.2 |

Each of the samples was produced in the following manner First, a raw material having a glass composition presented in Tables 1 to 3 was prepared, subjected to press molding, and subjected to sintering at 1400° C. for 5 hours, resulting in a glass raw material block.

Next, the glass raw material block was coarsely ground in a mortar, resulting in 0.5 g of small pieces of the glass raw material block. The resulting small pieces of the glass raw material block were subjected to the containerless levitation technique using a device in accordance with FIG. 1, resulting in a glass material (having a diameter of approximately 8 mm). Note that a 100 W CO₂ laser oscillator was used as the heating source. Nitrogen gas was used at a supply rate from 1 to 30 L/min to levitate the glass raw material block. The resulting glass material was annealed in an air atmosphere at 770° C. for 1 hour, and then subjected to the following measurements. The results are presented in Tables 1 to 3.

The Verdet constant was measured using a rotating analyzer method. Specifically, the resulting glass material was polished to a thickness of 1 mm; then, the Faraday rotation angle in the wavelengths from 500 nm to 1100 nm in the magnetic field of 10 kOe was measured, and the Verdet constant at the wavelength of 1064 nm was calculated.

The light transmittance was measured using a spectrophotometer (V-670 available from JASCO Corporation). Specifically, the resulting glass material was polished to a thickness of 1 mm; then, the light transmittance at a wavelength of 1064 nm was read from a light transmittance curve. Note that, the light transmittance is an external light transmittance including reflection.

The ratio of Tb³⁺ to the total Tb was measured using X-ray absorption fine structure analysis (XAFS). Specifically, the spectrum of the X-ray absorption near edge structure region (XANES) was obtained, and the ratio (mol%) of Tb³⁺ to the total Tb was calculated from the amount of shift of the peak position of each Tb ion.

As presented in Tables 1 to 3, the absolute values of the Verdet constants of the glass materials of Examples 1 to 10 and Examples 12 to 16 were from 0.083 to 0.163 min/Oe·cm at the wavelength of 1064 nm. The light transmittance was 80% or greater at the wavelength of 1064 nm in each of Examples 1 to 10 and Examples 12 to 16, indicating a good light transmittance.

Meanwhile, the glass material of Comparative Example 11 had a low light transmittance of 69.2% at the wavelength of 1064 nm.

### INDUSTRIAL APPLICABILITY

The glass material according to the present invention can be suitably used in a magneto-optical element (for example, a Faraday rotator) constituting a magnetic device such as an optical isolator, an optical circulator, or a magnetic sensor.

1. A glass material comprising, in terms of % by mole, from 26% to 40% of Tb₂O₃, greater than 12% and 40% or less of B₂O₃, from 1% to 20% of Al₂O₃, from 1% to 40% of SiO₂, from 0% to 5% of P₂O₅, and greater than 14% and 74% or less of B₂O₃+Al₂O₃+SiO₂+P₂O₅.

2. The glass material according to claim 1, wherein a content of FeO+Fe₂O₃ is 10 ppm or less.

3. The glass material according to claim 1, wherein the glass material is substantially free of Sb₂O₃ and Aₛ₂O₃.

4. The glass material according to claim 1, wherein a ratio of Tb³+ to the total Tb is, in terms of % by mole, 55% or greater.

5. The glass material according to claim 1, wherein a light transmittance at a wavelength of 1064 nm is 60% or greater.

6. The glass material according to claim 1, wherein the glass material is for use as a magneto-optical element.

7. The glass material according to claim 6, wherein the glass material is for use as a Faraday rotator.
